(19) United States
(12) Patent Application Publication
(10) Pub. No.: US 2004/0257614 A1
(43) Pub. Date: Dec. 23, 2004

(54) Communication device and communication system

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 10/857,970

(22) Filed: Jun. 2, 2004

(30) Foreign Application Priority Data
Jun. 4, 2003 (JP) 2003-160124
Jun. 16, 2003 (JP) 2003-171207

(51) Int. Cl. G06F 15/173; G06F 11/30; G06F 3/00; G06F 12/14; H04L 9/32; H04L 12/28

(52) U.S. Cl. 358/1.15; 709/228; 713/201; 710/11; 710/16

(57) ABSTRACT

A communication device of a transmitter acquires a URL of a reception field associated with a prescribed process from a communication device of a recipient. The communication device of the transmitter writes a file into the reception field specified by the URL. The communication device of the transmitter executes the process associated with the reception field by using the written file. Accordingly, since communication can be carried out between the communication devices just by a file operation, the communication protocol can be unified easily and communication can be carried out between different types of devices.

### BACKGROUND OF THE INVENTION

1. Field of the Invention

The present invention relates to communication technology between devices, and more particularly to technology for carrying out communication of data between the devices. The present invention also relates to operation technology of a prescribed device, and more particularly to technology for instructing a prescribed device to execute a prescribed process and interface technology for carrying out the instruction.

2. Description of the Related Art

Communication devices having a communication function, such as a printer, a scanner, a facsimile machine and a Multi Functional Peripheral (MFP), are becoming widespread. The communication devices are connected to a network such as a Local-Area Network (LAN) and shared by a plurality of terminals. In general, when transmitting and receiving information between devices, the devices of both sides carry out a negotiation in advance and exchange an ability of the device, such as a protocol to be used for the communication, a communication speed and a memory capacity, to decide the protocol to be used for the communication and the communication speed in advance. There is technology that carries out such a negotiation by using electronic mail.

In general, to use the communication devices, it is necessary to set in advance, various pieces of information such as an Internet Protocol (IP) address or a registration of a user that uses the communication device. There is technology that carries out a setting process of such pieces of information from a terminal via a network.

To carry out communication, it is necessary to correspond the protocol to be used by a device of a transmitter and a device of a recipient. Then, in accordance with the protocol, a command or data that is specific to the communication devices is transmitted and received. Since the protocol is optimized for each different type of communication device, it was difficult for different types of communication devices to transmit and receive information.

Accompanying an increase in the number of communication devices connected to a network, a user frequently instructs via the network, various processes such as an imaging process of a printed material by a network scanner or a printing process of image data by a network printer. An interface for operating a communication device differs according to each communication device. Moreover, since each interface is independent, for example, when printing out an image scanned by a scanner from a printer, first, image data is obtained by using an interface for operating the scanner. Then, by using an interface for operating the printer, an instruction is made to print out the image data. As described, since each communication device has a different interface, as the number of usable communication devices increases, the number of interfaces to be used by the user also increases. Furthermore, since it is necessary to carry out an intended process by switching an interface between a plurality of interfaces, there are cases in which the user feels the operation to be troublesome.

### SUMMARY OF THE INVENTION

The present invention has been made in view of such circumstances. An advantage of the present invention is to provide technology for carrying out transmission and reception of data with a target communication device. Another advantage of the present invention is to provide interface technology for instructing a prescribed device to execute a prescribed process.

An aspect of the present invention is a device that communicates with a target device of the communication and executes a prescribed process. The device includes a storage unit that is specified by identification information in a network and that stores a file to be used by the device for executing a prescribed process. The device also includes a writing unit that accepts from the target device, an instruction to write a file for executing a prescribed process into the storage unit specified by the identification information and writes the instruction into the storage unit. In addition, the device includes a control unit that executes a prescribed process associated with the storage unit by using a file when the file is written into the storage unit.

Accordingly, a prescribed process can be instructed to a target device of the communication by carrying out a write operation of a file. The “identification information” can be information such as a Uniform Resource Locator (URL) or a Uniform Resource Identifiers (URI) that uniquely specifies a file or a folder on the network.

The device further includes an authentication unit that carries out an authentication of a transmitter device which is requesting a writing of a file. In case of succeeding in the authentication, the writing unit can write the file into the storage unit. Accordingly, an execution authority can be set for each process.

The device can further include a writing unit that writes an execution result of the process based on the file into a prescribed field of a transmitter device of the file. Accordingly, the execution result can be notified to the transmitter device.

Another aspect of the present invention is a communication device of a transmitter. The communication device of the transmitter includes an acquiring unit that acquires from a target device of communication, machine information indicating a present status of the target device. The communication device of the transmitter also includes a determination unit that determines whether the communication can be carried out, in accordance with the machine information. In addition, the communication device of the transmitter includes a writing unit that writes a file for executing a prescribed process by the target device into a storage field of the target device associated with unique identification information on the network, when the communication can be carried out. Accordingly, by carrying out a file operation, a process can be executed by the communication device.

The machine information includes identification information and a content of a process carried out when a file is written into a storage field that can be specified by the identification information. The writing unit can read from the machine information, identification information that specifies a storage field for executing a desired process, and write the file into a storage area that can be specified by the identification information. Accordingly, by writing a file into the storage field for executing the desired process, the desired process can be executed.

According to the present invention, by carrying out a file operation to a reception field of a desired device, a prescribed process can be executed.

Another aspect of the present invention is a device that communicates with a target device of the communication and executes a prescribed process. The device includes an output unit that assumes information relating to the device as a folder or a file and outputs to the target device, information for controlling the device by using an interface for the file operation. The device also includes an accepting unit that accepts from the target device, a file operation for executing a prescribed process, and a processing unit that executes a prescribed process in accordance with the accepted file operation. Accordingly, the target device can be operated by a unified interface based on the file operation. The folder can be provided for each process in the target device. Accordingly, a user can move a file to a folder for implementing a desired process and the desired process can be executed.

The folder or the file includes an operation content of a prescribed process in the communication device. The accepting unit can interpret the accepted file operation as an operation instruction for the operation content included in the operated folder or file. For example, in case the communication device is a facsimile machine, the “operation content” is various pieces of setting information, a transmitting process, a receiving process, a printing process, data of an original document or the like of the communication device. The “operation content” can be contents of various processes that can be executed by the communication device, data to be used for the process, the setting information or the like.

The file can be at least one of data to be used for executing a prescribed process and internal information of the communication device. The “internal information” is various pieces of information relating to the communication device such as job information and machine information.

The folder can indicate at least one of a prescribed process in the communication device and the communication device. For example, in case the communication device is a facsimile machine, as a folder indicating a prescribed process, there are a transmission job and a reception job or the like.

The device further includes an authentication unit that carries out an authentication of a user when accepting a file operation. The processing unit can execute to the accepted file operation, a process according to authentication information.

In accordance with the authentication information, the output unit can output information for controlling the process according to the authentication information via the interface for the file operation. The output unit can assume information, which relates to another communication device that can be controlled by the communication device, as a folder or a file. Then, the output unit can output information for controlling another communication device by using the interface for the file operation and information showing a hierarchy relation so that a folder or a file relating to the another communication device is located below a hierarchy of a folder indicating the communication device.

Another different aspect of the present invention is a communication device. The communication device includes a receiving unit that receives from a target device of the communication, information relating to the target device. The communication device also includes a display unit that assumes information relating to the target device as a folder or a file in accordance with the received information and displays the folder or the file as an interface for a file operation. The communication device further includes an instruction unit that carries out an operation instruction to the target device in a manner of carrying out a file operation. Accordingly, the user can grasp a machine status intuitively. The display unit can display for each content of the processes that can be executed by the target device.

The display unit can change a format of the interface for the file operation according to the process that can be executed by the target device.

Another aspect of the present invention is a communication system. The communication system includes a second communication device that executes a prescribed process and a first communication device that carries out an operation instruction to the second communication device. The second communication device includes an output unit that assumes information relating to the second communication device as a folder or a file, and outputs to the first communication device, information for controlling the second communication device by using the interface for the file operation. The second communication device also includes an accepting unit that accepts a file operation for executing a prescribed process from the first communication device, and a processing unit that executes a prescribed process in accordance with the accepted file operation. The first communication device includes an acquiring unit that receives information relating to the second communication device. The first communication device also includes a display unit that assumes the information relating to the second communication device as a folder or a file in accordance with the acquired information and displays the folder or the file as an interface for a file operation. The first communication device further includes an operation unit that carries out an operation instruction to the second communication device in a manner of carrying out a file operation.

The communication system includes a plurality of second communication devices. The display unit can divide the second communication devices into groups and display each of the second communication devices in a hierarchy structure for each of the groups.

According to the present invention, since an interface for handling a communication device can be presented in a manner of carrying out a file operation, convenience of the user is improved.

Further, any conversion of the combination of the above constituent elements or the expression of the present invention between a method, a device, a system, a recording medium, a computer program or the like is also effective as an embodiment of the present invention.

### BRIEF DESCRIPTION OF THE DRAWINGS

FIG. 1 is a block diagram of a communication system according to a first embodiment of the present invention.

FIG. 2 shows an example of an interface for operating a communication device of a transmitter.

FIG. 3 is a block diagram showing an inner configuration of a communication device of a recipient of FIG. 1.

FIG. 4 is a block diagram showing an inner configuration of a communication device of a transmitter of FIG. 1.

FIG. 5 shows an example of a data structure of response data including machine information of FIG. 1.

FIG. 6 is a block diagram showing a communication system according to a second embodiment of the present invention.

FIG. 7 shows an example of an interface for controlling a second communication device.

FIG. 8 is a block diagram showing an inner configuration of a first communication device of FIG. 6.

FIG. 9 is a block diagram showing an inner configuration of the second communication device of FIG. 6.

FIG. 10 shows another example of a Graphical User Interface (GUI) provided by the first communication device of FIG. 6.

### DETAILED DESCRIPTION OF THE PREFERRED EMBODIMENTS

### First Embodiment

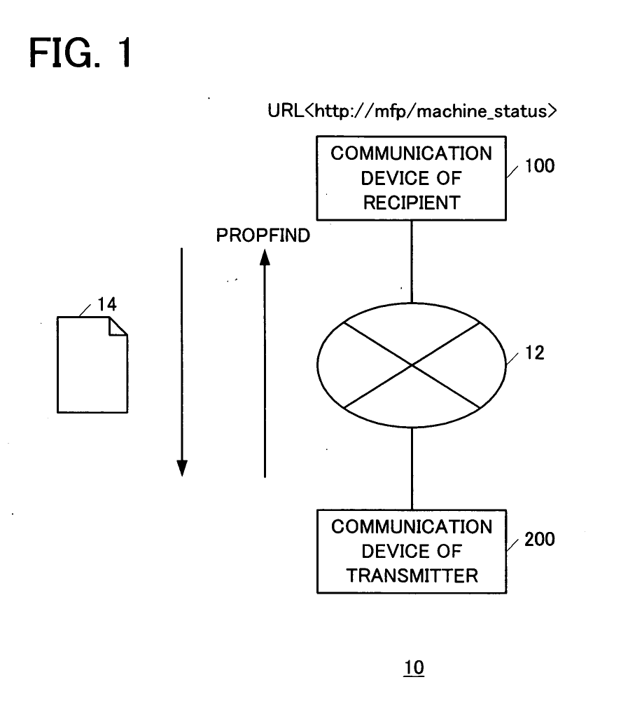

FIG. 1 is a block diagram of a communication system 10 according to a first embodiment of the present invention. A communication device of a recipient 100 and a communication device of a transmitter 200 communicate via a network 12. The communication device of the recipient 100 and the communication device of the transmitter 200 can be a device having a communication function, such as a facsimile machine, a MFP, a scanner, a computer, a server and a video recorder. In the first embodiment, a description will be made on a case in which the communication device of the recipient 100 and the communication device of the transmitter 200 are facsimile machines.

The communication device of the recipient 100 and the communication device of the transmitter 200 carries out communication by using the World Wide Web Distributed Authoring and Versioning (WebDAV) or the like. The WebDAV is a protocol that is an extension of the Hyper Text Transfer Protocol (HTTP). The WebDAV can acquire a file specified by a Uniform Resource Locator (URL) or the like. The WebDAV is also capable of a file operation such as uploading and downloading of a file. By acquiring a file or carrying out the file operation by the protocol like the WebDAV, a number of protocols provided in the communication device of the recipient 100 and the communication device of the transmitter 200 can be reduced. In addition, since a number of ports used for the communication can be reduced, a security level of the communication system 10 can be improved.

The communication device of the recipient 100 holds machine information including a receiving ability and device information or the like. Further, the receiving ability is a file format that can be received, in other words, a file format or data format that can be processed. The device information is a size of data that can be received, a remaining memory, error information of the device or the like. Identification information such as a URL for uniquely identifying the communication device of the recipient 100 on the network 12 is set in the communication device of the recipient 100. A URL is also associated with the machine information (hereinafter simply referred to as the “machine information URL”). When receiving a request to present the machine information specified by the machine information URL, the communication device of the recipient 100 transmits the machine information to a destination that requested the machine information.

The communication device of the recipient 100 also sets a URL to a reception field for receiving a facsimile image (hereinafter simply referred to as the “reception URL”). The reception URL is published to a remote device. When a file is written into the reception field specified by the reception URL, a prescribed process is executed in accordance with the file. For example, the file can be printed as a facsimile image, or an incoming call can be notified to the user. The reception field can be provided for each content of the processes. For example, a reception field for carrying out a printing process in accordance with a written file, a reception field for transmitting the written file to a prescribed address by using electronic mail, a reception field for notifying that a file has been written, a reception field for circulating the written file in a predetermined circulation order, and a reception field for handling the file as confidential for each user can be associated with different reception URLs, respectively.

Accordingly, the communication device of the transmitter 200 can execute a prescribed process by writing a file into a reception field for executing a desired process, in other words, by a simple file operation. That is, if the file operation can be carried out, communication can be carried out between different types of devices and a desired process can be executed. For example, when a video recorder writes a file of an Electronic Program Guide (EPG) into the MFP, a screen of the EPG becomes printable. To implement this process, the communication device of the recipient 100 associates the reception URL with the content of the process, and stores as machine information. By acquiring the machine information, the communication device of the transmitter 200 can acquire the reception URL for implementing the desired process.

The communication device of the transmitter 200 writes a facsimile image into a reception field specified by the reception URL of the communication device of the recipient 100. Prior to transmission of the facsimile image, the communication device of the transmitter 200 acquires machine information from the communication device of the recipient 100. The communication device of the transmitter 200 extracts a reception URL from the machine information for executing a desired process, and writes the facsimile image into the reception field specified by the reception URL.

For example, in the machine information, a command indicating the content of the process and the reception URL are associated with one another. The communication device of the transmitter 200 can extract a reception URL for implementing a desired process in accordance with the command. Then, the communication device of the transmitter 200 transmits the facsimile image to the reception URL. Accordingly, the communication device of the recipient 100 executes the command associated with the reception URL. The communication device of the transmitter 200 can instruct the communication device of the recipient 100 to execute a prescribed process just by carrying out such a file operation.

For handling a web resource, new concepts such as “property”, “collection” and “lock” are introduced to the WebDAV.

The “resource” indicates a file or a collection to be described later that are to be managed by the WebDAV.

The “collection” is a concept for collectively managing a plurality of resources, and a concept same as a directory or a folder.

The “property” defines an attribute of the resource by a group of a name and a value. Although the detail will be described later, in the first embodiment, machine information is stored by using the property. The property includes a live property that can be set and managed by a server and a dead property that can be set and managed by a client.

The “lock” is a mechanism for preventing a plurality of clients from writing into one resource.

The communication device of the recipient 100 holds as a property of a prescribed resource, machine information relating to the communication device of the recipient 100 such as a reception URL for each content of a process, a file format that can be received, a remaining memory, a generation of an error, a number of jobs and a condition of the job. The resource is associated with the machine information URL. That is, the communication device of the transmitter 200 can acquire the machine information by designating the machine information URL. Specifically, the communication device of the transmitter 200 sets “http://mfp/machine_setting” to an argument of “PROPFIND” command in the WebDAV protocol, and transmits to the communication device of the recipient 100. As a response, the communication device of the recipient 100 transmits machine information 14 to the communication device of the transmitter 200.

The machine information 14 is an extensible Markup Language (XML) format and each piece of information is surrounded by a tag. Since the machine information 14 is the XML format, each piece of the information can be retrieved easily. In accordance with function information included in the machine information 14, the communication device of the transmitter 200 selects a communication function to be used for the communication and acquires the information to be used.

As described above, the property includes the live property and the dead property. In the live property, information that cannot be rewritten by the communication device of the transmitter 200 is set. For example, the reception URL, the file format that can be received and the remaining memory or the like are set as the live property. In the dead property, information that can be rewritten by the communication device of the transmitter 200 is set. For example, information indicating that a facsimile image has been transmitted and information of the transmitter are written into the dead property by the communication device of the transmitter 200.

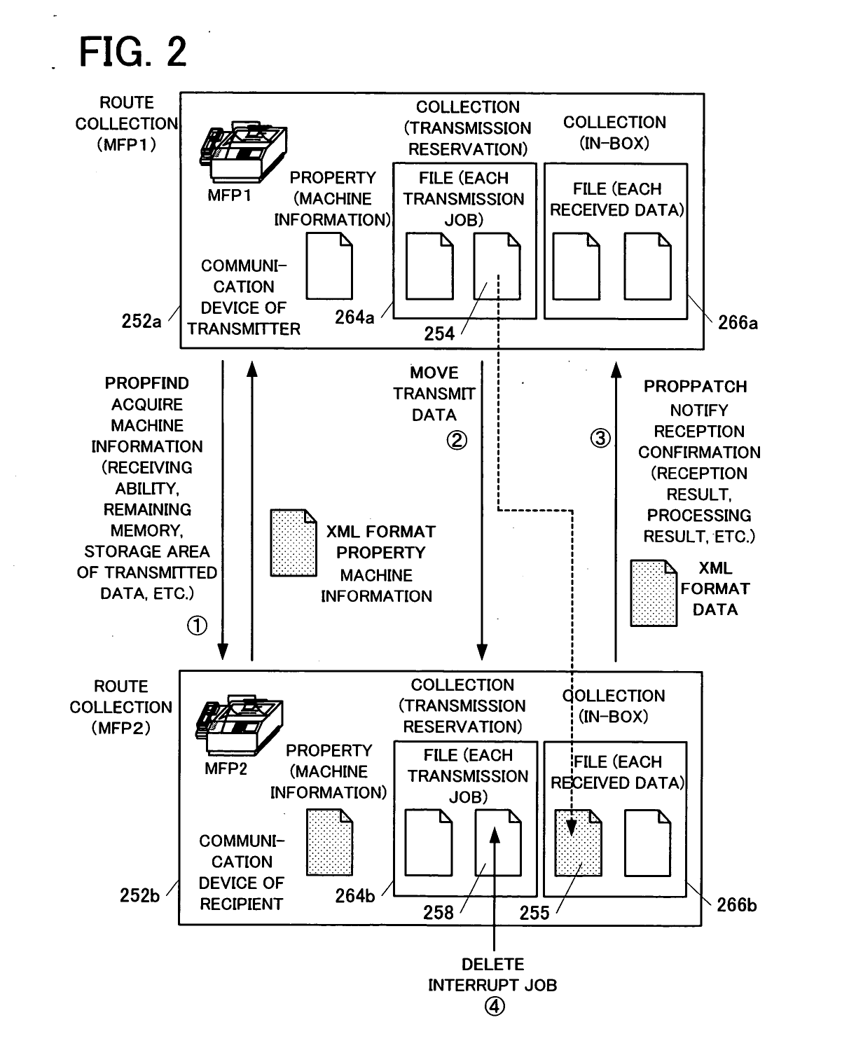

FIG. 2 is a drawing for describing the process carried out by the communication device of the recipient 100 and the communication device of the transmitter 200. By moving a resource in a manner of handling a file, the communication device of the transmitter 200 can instruct the communication device of the recipient 200 to execute a process. The communication device of the transmitter 200 includes a property 252a, a first transmission reservation collection 264a and a first reception collection 266a which are the machine information in the communication device of the transmitter 200. The first transmission reservation collection 264a is a collection for holding a resource which a transmission reservation has been made, and each transmission job is held as a file in the collection. The first reception collection 266a holds as a file, facsimile data received from another facsimile.

The communication device of the recipient 100 includes a property 252b, a second transmission reservation collection 264b and a second reception collection 266b which are the machine information in the communication device of the recipient 100. Various pieces of machine information are included in the property 252b. According to a request of the communication device of the transmitter 200, all of or a part of the various pieces of machine information is transmitted as the machine information 14. The second transmission reservation collection 264b is a collection for holding a transmission job like the first transmission reservation collection 264a. The second reception collection 266b is a collection for holding the received facsimile data like the first reception collection 266a. Next, a description will be made on the communication process of the communication device of the recipient 100 and the communication device of the transmitter 200.

(1) When acquiring the machine information from the communication device of the recipient 100 of FIG. 1.

Prior to the communication, the communication device of the transmitter 200 acquires the machine information 14 set as the property of the machine information URL by a “PROPFIND” command of the WebDAV. For example, the machine information 14 includes a reception URL, a file format and a remaining memory.

(2) When transmitting to the communication device of the recipient 100 of FIG. 1, a resource which is a facsimile image scanned by using a scanner or the like by the communication device of the transmitter 200 of FIG. 1.

The communication device of the transmitter 200 writes a first file 254 into the second reception collection 266b. Accordingly, a second file 255 is written into the second reception collection 266b. At this time, the communication device of the transmitter 200 issues a “MOVE” command. As an argument of the “MOVE” command, the reception URL of the second reception collection 266b of the communication device of the recipient 100 is set. Accordingly, a transmission reservation is made, and at a prescribed timing, for example, when a communication line is opened or when a set time is reached, the communication device of the transmitter 200 writes the facsimile image into the second reception collection 266b. Then, when the transmission ends, the communication device of the transmitter 200 deletes the file of the facsimile image from the first transmission collection 264a.

(3) The communication device of the recipient 100 notifies a reception result of the facsimile image to the communication device of the transmitter 200. After the reception of the facsimile image has been completed, the communication device of the recipient 100 issues a “PROPPATCH” command, and writes the reception result into the property of the communication device of the transmitter 200 specified by a prescribed URL. For example, the reception result is a completion of the reception and a generation of an error. The URL for writing the reception result is included in the machine information 14.

(4) When interrupting a job which a transmission reservation has been already made.

For example, when interrupting a job which a transmission reservation has been made with the communication device of the recipient 100, the communication device of the recipient 100 deletes a third file 258. For this process, a “DELETE” command having a file name of the third file 258 as an argument can be issued to the communication device of the recipient 100.

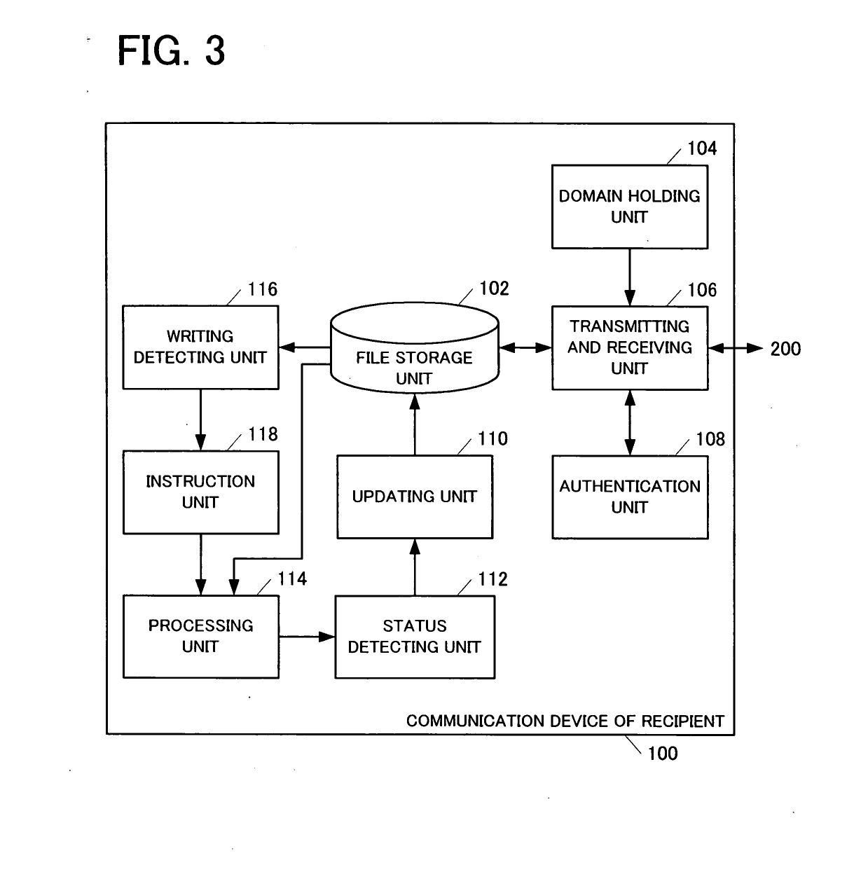

FIG. 3 is a block diagram showing an inner configuration of the communication device of the recipient 100 of FIG. 1. Each of constituent elements of the communication device of the recipient 100 is mainly realized by a Central Processing Unit (CPU) of a computer, a memory, a program loaded in the memory for realizing the constituent elements, a storage unit such as a hard disk for storing the program, an interface for establishing a network connection or the like. It is to be understood by those skilled in art that there are variations and modifications to the method and the device for realizing each of the constituent elements. FIG. 3 shows blocks representing units of function, instead of units of hardware.

A domain holding unit 104 holds information that uniquely specifies the communication device of the recipient 100 in the network 12 of FIG. 1, such as a domain name, a computer name or an IP address of the communication device of the recipient 100. A transmitting and receiving unit 106 is a functional block that provides the machine information 14 in accordance with the WebDAV protocol. When receiving a PROPFIND command, the transmitting and receiving unit 106 reads from a file storage unit 102, the machine information which is the property of the resource of the machine information URL designated by the command. Then, the transmitting and receiving unit 106 outputs the machine information 14 of FIG. 1 as a response. When receiving a PROPPATCH command, the transmitting and receiving unit 106 writes data designated by the command into the property of the resource of the URL designated by the command. Specifically, the transmitting and receiving unit 106 accepts information of the transmitter or error information or the like from the communication device of the transmitter 200 and writes the accepted information into the property.

The file storage unit 102 stores a resource that is to be managed by the WebDAV. In the first embodiment, the file storage unit 102 holds a resource specified by a URL “http://mfp/machine_status”. The property of the resource is the machine information. Accordingly, the machine status of the communication device 100 can be managed by an operation to reference or change a shared file on the network. As another example, the machine information can be set to a body of the resource, instead of the property.

However, the PROPFIND command of the WebDAV protocol can retrieve only a part of the setting information that is necessary for the process, and output the retrieved information as a response. Therefore, instead of developing such a function independently, it is more efficient to use the function of the WebDAV as it is. Of course, there is no problem if such a function is developed independently.

The file storage unit 102 also holds a resource associated with the content of the process. Although the detail will be described later, when a file is written into the collection as a resource, a process associated with the resource is executed by using the written file.

Since the WebDAV is a protocol which is an extension of the HTTP, an access authority can be set for each file stored in the file storage unit 102. Therefore, by setting a password to an important resource such as the machine information, for example, only a manager can rewrite the device information via the network.

For example, an authentication unit 108 carries out an authentication when an authority is set to the resource, and permits only a specific device to provide or update the resource and the property.

A processing unit 114 is a functional block for executing a prescribed process in accordance with the file written into the file storage unit 102. For example, the processing unit 114 executes a printing process for printing the written file, a process for transmitting the file by using electronic mail and a process for notifying an incoming call of the file.

A status detecting unit 112 detects a status of the communication device 100 by the process carried out by the processing unit 114. When there is a change in the status, the status detecting unit 112 outputs such a fact to an updating unit 110. For example, the status detecting unit 112 detects a communication status of the network, a reception condition of the facsimile image, a remaining memory or the like. The status detecting unit 112 is grasping in advance, the machine status to be detected by the status detecting unit 112. When detecting such a machine status, the status detecting unit 112 can notify such a fact to the updating unit 110.

The updating unit 110 writes the detected machine information into the machine information, i.e., the property, and updates the data. Accordingly, among the machine information, a piece of the machine information which the status changes is updated at all times.

A writing detecting unit 116 detects whether or not a new writing has been made to the file storage unit 102. For example, the writing detecting unit 116 can detect a writing made to the file storage unit 102 by the transmitting and receiving unit 106. Alternatively, the writing detecting unit 116 can compare a date and time when the resource was stored, the present date and time, and a date and time when a previous writing was detected. In case the date and time when the resource was stored is closer to the present date and time than the date and time when the previous writing was detected, the writing detecting unit 116 can detect the writing as a newly written resource. Then, when detecting a writing, the writing detecting unit 116 notifies such a fact to an instruction unit 118.

According to a reception field in which the writing has been made, the instruction unit 118 instructs the processing unit 114 to execute a process associated with the reception field. For example, the instruction unit 118 holds a table that associates a directory with the content of the process. When a writing has been detected newly, the instruction unit 118 specifies a path of the newly written file and specifies a directory from the path. Then, the instruction unit 118 specifies the content of the process associated with the specified directory. The directory can be specified by the reception URL. For example, when a facsimile image is written into a reception field which is associated with a printing process, the instruction unit 118 instructs the processing unit 114 to print out the facsimile image. As described above, the communication device of the recipient 100 can control to handle the file on the network.

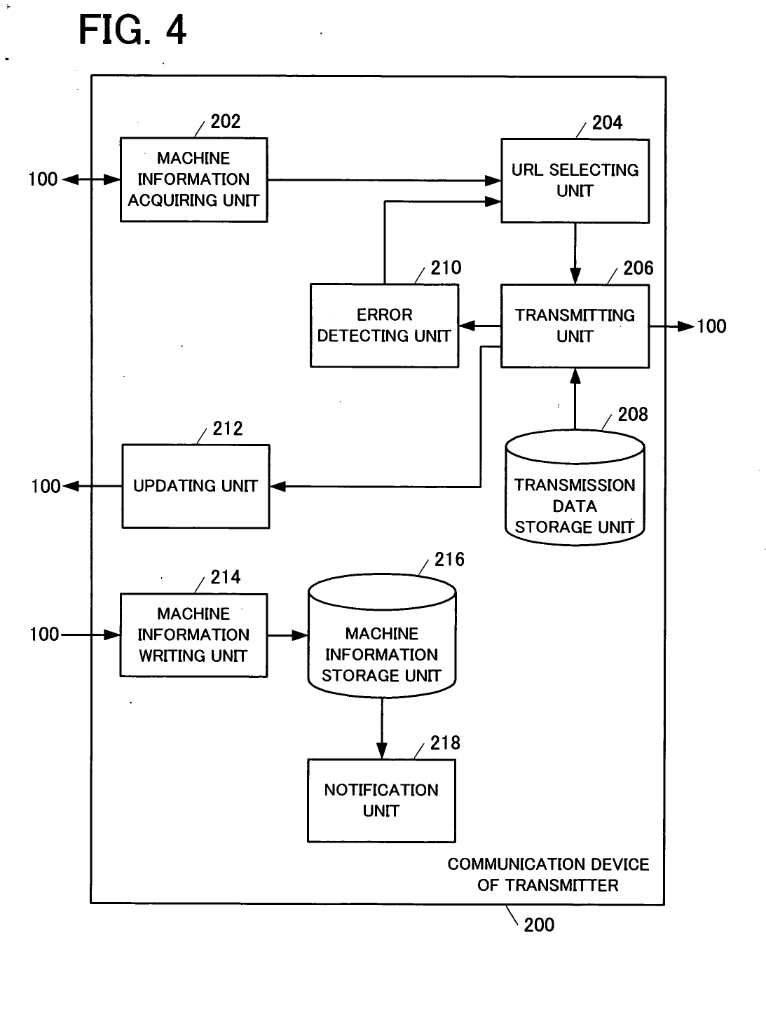

FIG. 4 is a block diagram showing an inner configuration of the communication device of the transmitter 200 of FIG. 1.

A machine information acquiring unit 202 acquires the machine information 14 from the communication device of the recipient 100. The machine information acquiring unit 202 can hold in advance, a machine information URL for acquiring the machine information 14 from the communication device of the recipient 100. Alternatively, the machine information acquiring unit 202 can accept a machine information URL from a manager. Moreover, for example, the machine information acquiring unit 202 can broadcast data for detecting the communication device of the recipient 100 and acquire the machine information 14 in accordance with a URL of a machine that responded to the broadcast. The machine information acquiring unit 202 outputs the acquired machine information 14 to a URL selecting unit 204.

The URL selecting unit 204 selects a reception URL for executing a desired process from the reception URL included in the machine information. Then, the URL selecting unit 204 outputs the selected reception URL to a transmitting unit 206. Specifically, the URL selecting unit 204 extracts from the machine information 14, the reception URL associated with the command indicating a desired process. In accordance with a command included in the machine information 14, the URL selecting unit 204 presents a list of executable processes to a user, e.g., a manager. Then, from the list of the executable processes, the URL selecting unit 204 can extract a reception URL for executing a designated process.

The transmitting unit 206 reads a facsimile image, which is transmission data, from a transmission data storage unit 208. Then, the transmitting unit 206 writes the facsimile image into the reception URL selected by the URL selecting unit 204. Specifically, the transmitting unit 206 issues a “MOVE” command or a “COPY” command in the WebDAV.

An error detecting unit 210 detects a communication error and instructs the URL selecting unit 204 to change the reception URL. For example, in case the communication device of the recipient 100 of FIG. 1 includes a first reception URL for a printing process and a second reception URL for notifying an incoming call to a prescribed user, and the first reception URL cannot be used due to lack of paper in the communication device of the recipient 100, the URL selecting unit 204 changes the first reception URL to the second reception URL and instructs again to write in the facsimile image.

An updating unit 212 to be described later writes into the machine information of the communication device of the recipient 100, a fact that an error has generated.

The transmitting unit 206 notifies the updating unit 212 that a transmission has been completed.

The updating unit 212 writes into the machine information of the communication device of the recipient 100, a communication function used for transmitting the facsimile image and a transmission date and time or the like. Accordingly, the communication device of the transmitter 200 can notify the communication device of the recipient 100 that the facsimile image has been transmitted. Moreover, when an error is generated, the updating unit 212 can write such a fact into the machine information of the communication device of the recipient 100. By receiving the notification, for example, the communication device of the transmitter 100 can notify the manager that there is a problem in the communication function, or can change a status of the process specified by the reception URL included in the machine information 14 into “error”.

A machine information writing unit 214 receives an execution result of the prescribed process from the communication device of the recipient 100 and writes the execution result into a machine information storage unit 216. For example, the status detecting unit 112 of FIG. 3 can detect the execution result of the prescribed process, and transmit such a fact to the communication device of the transmitter 200 or notify the execution result via the transmitting and receiving unit 106.

A notification unit 218 notifies to the user, the execution result stored in the machine information storage unit 216.

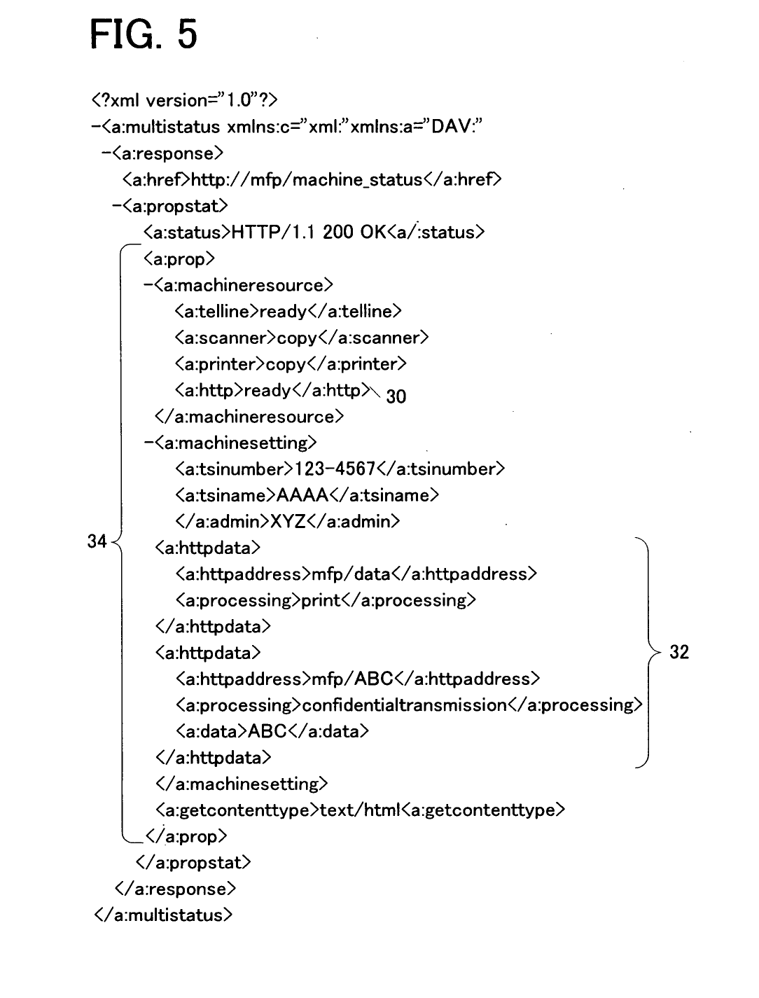

FIG. 5 shows an example of a data structure of response data including the machine information 14 of FIG. 1. In FIG. 5, a range surrounded by <a:prop> and </a:prop> is a property 34, in other words, the machine information 14.

The machine information 14 holds for each item, information indicating communication functions of the communication device of the recipient 100 of FIG. 1 and the status of the communication device 100, and information for using each of the communication functions.

A machine status field 30 holds information indicating that communication based on the WebDAV can be used. A set information field 32 holds a reception URL for when using the WebDAV, a content of a process carried out when a writing is made in the reception field specified by the reception URL, an argument according to the content of the process or the like. For example, when a file is written into a reception URL “http://mfp/data”, the communication device of the recipient 100 executes a printing process. Moreover, when a file is written into the reception URL “http://mfp/ABC”, the communication device of the recipient 100 carries out transmission confidentially to a user “ABC”. The communication functions of the communication device of the recipient 100 and usage information for using the communication functions are also set in the machine information 14.

The first embodiment of the present invention has been described. The above-described embodiment is an example and it is to be understood by those skilled in the art that there are variations to combinations of each of the constituent elements and each of the processes and those variations also fall within the scope of the present invention.

For example, the communication device of the recipient 100 and the communication device of the transmitter 200 can be built in a device that implements various functions such as a facsimile function, a printer function, a scanner function, a workflow function, a document management function, a program recording function, a program playing function and an air conditioning function. The communication device of the recipient 100 and the communication device of the transmitter 200 can be built in a same chassis. That is, the communication device of the recipient 100 can be attached to any device if the device includes a communication function.

### Second Embodiment

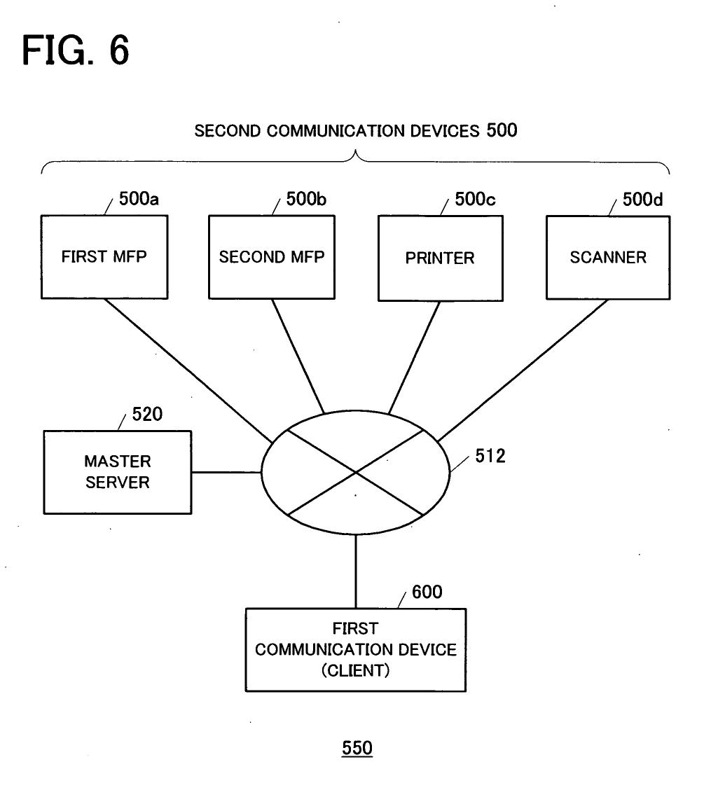

FIG. 6 is a block diagram of a communication system 550 according to a second embodiment of the present invention. A first MFP 500a, a second MFP 500b, a printer 500a and a scanner 500d (hereinafter simply referred to as the “second communication devices 500”) are connected to a first communication device 600 via a network 512. A master server 520 manages each of the second communication devices 500 for each attribute of the device, respectively.

For example, the “attribute of the device” indicates functions provided by the second communication devices 500, such as a network scanner, a network facsimile, a network printer, a video recorder, a television, a refrigerator and an air conditioner. In FIG. 6, for example, the first MFP 500a and the second MFP 500b are the same attribute. The first communication device 600 is connected to the master server 520 and the second communication devices 500 via the network 512. The first communication device 600 communicates with the second communication devices 500 and the master server 520 by using the WebDAV protocol.

In the second embodiment, the second communication devices 500 on the network are abstracted as one collection. For example, the machine information is set in a property of the collection. Accordingly, the second communication devices 500 can be expressed by using a URL and controlled based on a file operation. In case the second communication devices 500 are abstracted by using the collection, a collection corresponding to a process is included in the collection of the second communication devices 500. For example, in case the second communication devices 500 are facsimile machines, a plurality of collections such as a transmission collection, a reception collection and an error collection are included in a collection that indicates the entire device.

To operate the machine information or each of the second communication devices 500, for example, the first communication device 600 exchanges a resource by using the WebDAV protocol, in other words, exchanges data by unit of files. The master server 520 manages the second communication devices 500 connected to the network 512. First, the first communication device 600 acquires from the master server 520, identification information such as a URL for acquiring the machine information of the second communication devices 500 connected to the network 512. Then, the first communication device 600 acquires the machine information of each of the second communication devices 500 in accordance with the acquired URL. Next, in accordance with the machine information, the first communication device 600 forms a unified interface for controlling each of the second communication devices 500 on the network.

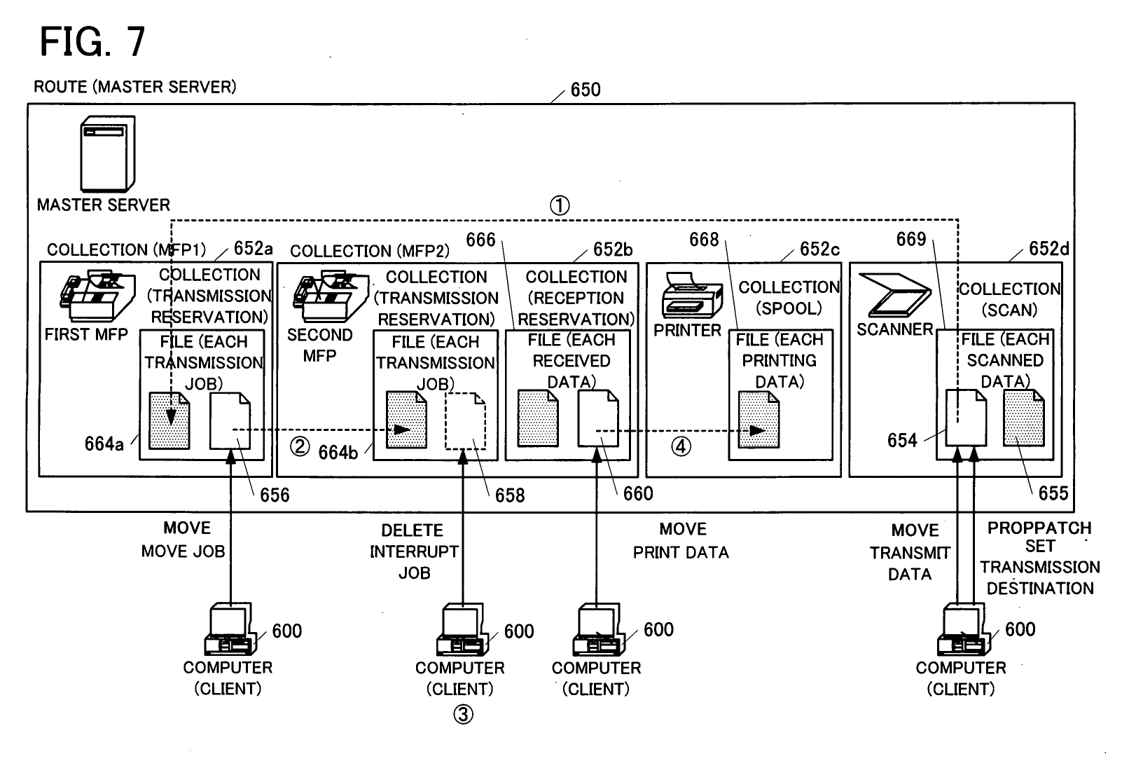

FIG. 7 shows an example of an interface for controlling the second communication devices 500. The first communication device 600 displays a Graphical User Interface (GUI) as shown in FIG. 7. When using the GUI, a process can be executed by a desired device by moving an icon that represents a resource to handle a file to an icon or a field that represents each device (hereinafter simply referred to as the “icon”).

A first collection 652a is an icon of the first MFP 500a of FIG. 6, and includes a first transmission reservation collection 664a. The first transmission reservation collection 664a is an icon of a collection of a resource which a transmission reservation has been made. A resource icon displayed in the first transmission reservation collection 664a represents each job.

A second collection 652b is an icon of the second MFP 500b of FIG. 6, and includes a second transmission reservation collection 664b and a reception collection 666. The reception collection 666 indicates that new facsimile data has been received from another facsimile and the data is shown by a resource icon.

A third collection 652c is an icon of the printer 500c of FIG. 6, and includes a spool collection 668 that displays a resource icon of a resource waiting for a printing process.

A fourth collection 652d is an icon of the scanner 500d of FIG. 6, and includes a scan collection 669 that displays a resource icon of a resource already scanned.

Next, a description will be made on a specific example for using an operation screen 650.

(1) When transmitting by facsimile from the first MFP 500a of FIG. 6, a resource scanned by the scanner 500d of FIG. 6.

The user selects a first file icon 654, and sets destination information to a property of a resource corresponding to the first file icon 654 by “PROPPATCH” command in the WebDAV.

Next, the user drags the first file icon 654 to the first transmission reservation collection 664a. At this time, the first communication device 600 issues a “MOVE” command to the scanner 500d. As an argument of the “MOVE” command, a URL of the first transmission reservation collection 664a of the first MFP 500a is set. Accordingly, the first file icon 654 moves to the first transmission reservation collection 664a. Accordingly, a transmission reservation is made for the resource, and under a prescribed timing, for example, when a communication line is released, a facsimile transmission is carried out to the destination set in the property. Then, when the transmission is completed, the resource icon is deleted from the operation screen 650.

(2) When changing the job which a transmission reservation is already made in the first MFP 500a of FIG. 6 to a job of the second MFP 500b of FIG. 6.

The user drags a second file icon 656 displayed in the first transmission reservation collection 664a to the second transmission reservation collection 664b. Accordingly, a “MOVE” command is issued, and a resource corresponding to the second file icon 656 is moved to the second transmission reservation collection 664b of the second MFP 500b. A number of resources waiting for transmission can be grasped from a number of resource icons included in the second transmission reservation collection 664b. Therefore, when it is necessary to transmit an original document urgently, the job can be changed to an MFP having a smaller number of original documents waiting for transmission.

(3) When deleting a job which a transmission reservation is already made in the second MFP 500b of FIG. 6.

The user selects and deletes a third file icon 658. Accordingly, the first communication device 600 issues to the second MFP 500b, a “DELETE” command having the resource for the third file icon 658 as an argument. Consequently, the job is interrupted.

(4) When printing by the printer 500c of FIG. 6, a resource received by the second MFP 500b of FIG. 6.

The user drags a fourth file icon 660 to the spool collection 668. At this time, the first communication device 600 issues a “MOVE” command to the second MFP 500b. As an argument of the “MOVE” command, the URL of the spool collection 668 of the printer 500c is set. Accordingly, a resource corresponding to the fourth file icon 660 moves to the spool collection 668 and is printed out. Moreover, a print option or the like can be changed by editing the property.

As described above, each of the second communication devices 500 can be controlled by a sense of operating a file. Therefore, the user can handle the GUI intuitively. Moreover, since a plurality of the second communication devices 500 can be handled by a unified interface, even when a number of devices to be handled increases, it is not necessary to install a new driver or learn how to use the new driver. Furthermore, since a manufacturer is not required to make a program or the like for making up an interface, a burden of the manufacturer can be reduced.

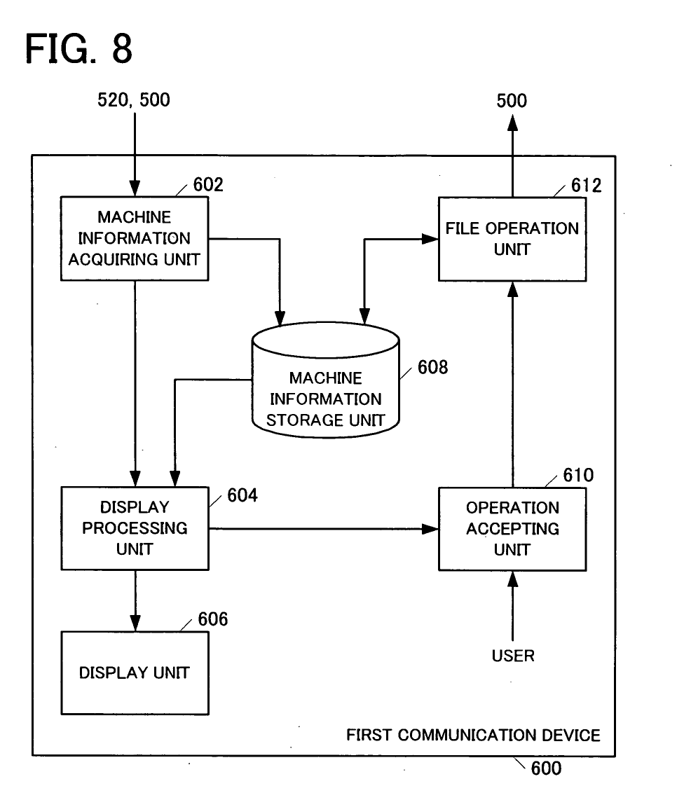

FIG. 8 is a block diagram showing an inner configuration of the first communication device 600 of FIG. 6.

Each of the constituent elements of the first communication device 600 is mainly realized by a CPU of a computer, a memory, a program loaded in the memory for realizing the constituent elements of FIG. 8, a storage unit such as a hard disk that stores the program, an interface for establishing a network connection or the like. It is to be understood by those skilled in the art that there are variations and modifications to the method and the device for realizing the constituent elements of the first communication device 600. Each of the drawings to be described hereinafter shows blocks representing units of function, instead of units of hardware.

A machine information acquiring unit 602 establishes a connection with the master server 520, and collects URLs for acquiring the machine information of each of the second communication devices 500 connected to the network 512. By using the acquired URLs, the machine information acquiring unit 602 acquires the machine information of each of the second communication devices 500. The machine information acquiring unit 602 can hold in advance, an address of the master server 520 in the network 512 or accept a designation of the address from an operator. Moreover, the machine information acquiring unit 602 can automatically search the master server 520. As another example, the master server 520 can be not provided. In this case, for example, the machine information acquiring unit 602 can broadcast data for detecting the second communication devices 500 and acquire the machine information in accordance with the URL of a machine that responded to the broadcast.

The machine information acquiring unit 602 stores the acquired machine information in a machine information storage unit 608, and notifies a display processing unit 604 that the acquired machine information has been stored. When detecting the master server 520 automatically, in the same manner, the machine information acquiring unit 602 can broadcast data and receive a response from the master server 520 to carry out the detection.

The display processing unit 604 acquires the machine information from the machine information storage unit 608 in accordance with the notification. Then, the display processing unit 604 generates the GUI as shown in FIG. 7 as an example and displays the GUI on a display unit 606. The machine information includes information such as a name of a machine, a content of a process and a collection. The display processing unit 604 can generate a folder having a hierarchy that is the same as the hierarchy structure of the collection. Alternatively, the display processing unit 604 can generate a folder for each content of a process.

An operation accepting unit 610 accepts an operation instruction from the user via an input device such as a mouse or a keyboard and outputs the instruction to a file operation unit 612. For example, the operation accepting unit 610 specifies an actual resource or the second communication devices 500 that are associated with an icon pointed by the mouse operated by the user. Then, the operation accepting unit 610 outputs to the file operation unit 612, information indicating which resource has been moved from which second communication devices 500 to which second communication devices 500.

The file operation unit 612 issues various commands of the WebDAV in accordance with the information from the operation accepting unit 610, and transmits the command to a corresponding device. Accordingly, in response to the operation of the user by the GUI, a WebDAV command can be issued and the command can be transmitted to each of the second communication devices 500 without the user being conscious.

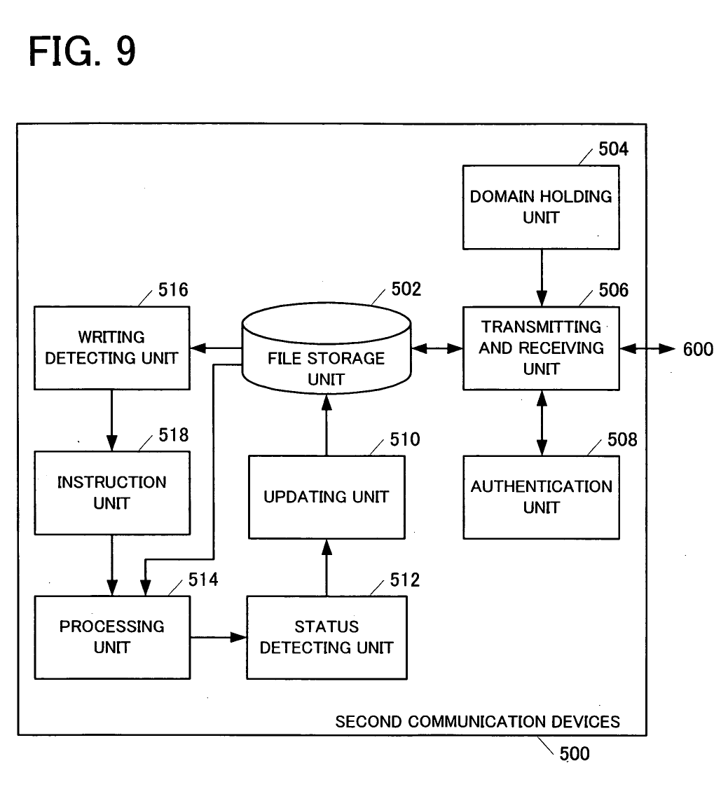

FIG. 9 is a block diagram showing an inner configuration of the second communication devices 500 of FIG. 6.

A domain holding unit 504 holds information that uniquely specifies the second communication devices 500 on the network, such as a domain name, a computer name and an IP address of the second communication devices 500.

A transmitting and receiving unit 506 is a functional block for carrying out communication in accordance with the WebDAV protocol. For example, when receiving a PROPFIND command addressed to the domain name held in the domain holing unit 504, the transmitting and receiving unit 506 reads from a file storage unit 502, a property of a resource of a URL designated by the command. Then, the transmitting and receiving unit 506 outputs the property as a response. When receiving a PROPPATCH command, the transmitting and receiving unit 506 writes data designated by the command into a property of a resource of a URL designated by the command. The transmitting and receiving unit 506 carries out an operation of the resource stored in the file storage unit 502 in accordance with a command such as COPY, MOVE and DELETE.

When the first communication device 600 requests a list of files of the received facsimile data or the transmission jobs included in the reception collection or the transmission collection stored in the file storage unit 502, the transmitting and receiving unit 506 generates information for displaying the received facsimile data or the transmission jobs by a folder and a file. Then, the transmitting and receiving unit 506 outputs the information to the first communication device 600.

For example, the transmitting and receiving unit 506 can generate and transmit a list of each collection and each file included in the collection. Alternatively, the transmitting and receiving unit 506 can transmit the list under a format of a directory structure in the general protocol for the file operation. The transmitting and receiving unit 506 can generate the list in accordance with each resource stored in the file storage unit 502 or in accordance with the information written in the property by a writing detecting unit 516 to be described later.

The file storage unit 502 stores a resource to be managed by the WebDAV. For example, the file storage unit 502 stores a resource specified by a URL “http://mfp/machine_status”, and a property of the resource is the machine information. Accordingly, the machine status of the second communication devices 500 can be managed by an operation to reference or change a shared file on the network. For example, in case of a facsimile machine, a reception collection and a transmission collection can be provided for each user. In this case, when succeeding in an authentication by using authentication technology to be described later, the transmitting and receiving unit 506 can provide the collection of each user. As another example, the machine information can be set in a body of a resource, instead of the property. However, the PROPFIND command of the WebDAV protocol can retrieve only a part of the setting information that is necessary for the process and output the retrieved information as a response. Therefore, instead of developing such a function independently, it is more efficient to use the function of the WebDAV as it is. Of course, there is no problem even if such a function is developed independently.

Moreover, since the WebDAV is a protocol that is an extension of the HTTP, an access authority can be set for each file stored in the file storage unit 502. Therefore, by setting a password to an important resource such as the machine information, for example, the machine information can be rewritten only by a manger via the network or the machine information can be managed for each user.

For example, an authentication unit 508 carries out an authentication when an authority is set to the resource, and permits only a specific user to provide or update the resource and the property.

A processing unit 514 can be either one of structures for implementing various functions such as a facsimile function, a printer function, a scanner function, a workflow function, a document management function, a program recording function, a program playing function and an air conditioning function. In other words, the second communication devices 500 can be attached to any device if the device includes a communication function.

A status detecting unit 512 detects a status of the second communication devices 500 by the process carried out by the processing unit 514. When the status changes, the status detecting unit 512 outputs such a fact to an updating unit 510. For example, in case the processing unit 514 includes a facsimile function, the status detecting unit 512 detects a busy status of a telephone line, a communication status of the network, a transmission status of a facsimile image, a reception status of a facsimile image or the like. The status detecting unit 512 is grasping in advance, a machine status which to be detected by the status detecting unit 512. When detecting the machine status, the status detecting unit 512 notifies such a fact to the updating unit 510. The updating unit 510 writes the detected machine status into the machine information, in other words, the property, and updates the data. Accordingly, among the machine information, a piece of the machine information which the status changes is updated at all times.

The writing detecting unit 516 detects whether or not a new writing has been made to the file storage unit 502. For example, the writing detecting unit 516 can detect a writing made to the file storage unit 502 by the transmitting and receiving unit 506. Alternatively, the writing detecting unit 526 can compare a date and time when the resource was stored, the present date and time, and a date and time when a previous writing was detected. In case the date and time when the resource was stored is closer to the present date and time than the date and time when the previous writing has been detected, the writing detecting unit 526 can detect the writing as a newly written resource.

When detecting a writing, the writing detecting unit 516 notifies the fact to an instruction unit 518. The writing detecting unit 516 writes into the property, a fact that a writing has been made and information that designates a storage area. For example, in the reception collection and the transmission collection, a storage area of the resource is set in advance by the URL. Then, when a file is written into the storage area specified by the URL, the processing unit 514 executes a prescribed process. In this case, the property can include a URL and information indicating whether or not a writing is made to the URL. When detecting a writing, the writing detecting unit 516 writes such a fact in the property. In accordance with the property, the transmitting and receiving unit 506 can generate a list of each collection and each file included in the collection.

The instruction unit 518 instructs the processing unit 514 to execute a prescribed process according to the content of the writing. For example, as a dead property, when a telephone number associated with each of speed dial buttons is rewritten, the instruction unit 518 instructs a module that manages the speed dial buttons of the processing unit 514 to read information relating to the newly changed speed dial button from the file storage unit 502. In case the processing unit 514 includes a printing function and a new resource is written into the file storage unit 502, the processing unit 514 reads the resource and executes a printing process. As described above, the second communication devices 500 can control to handle the file on the network.

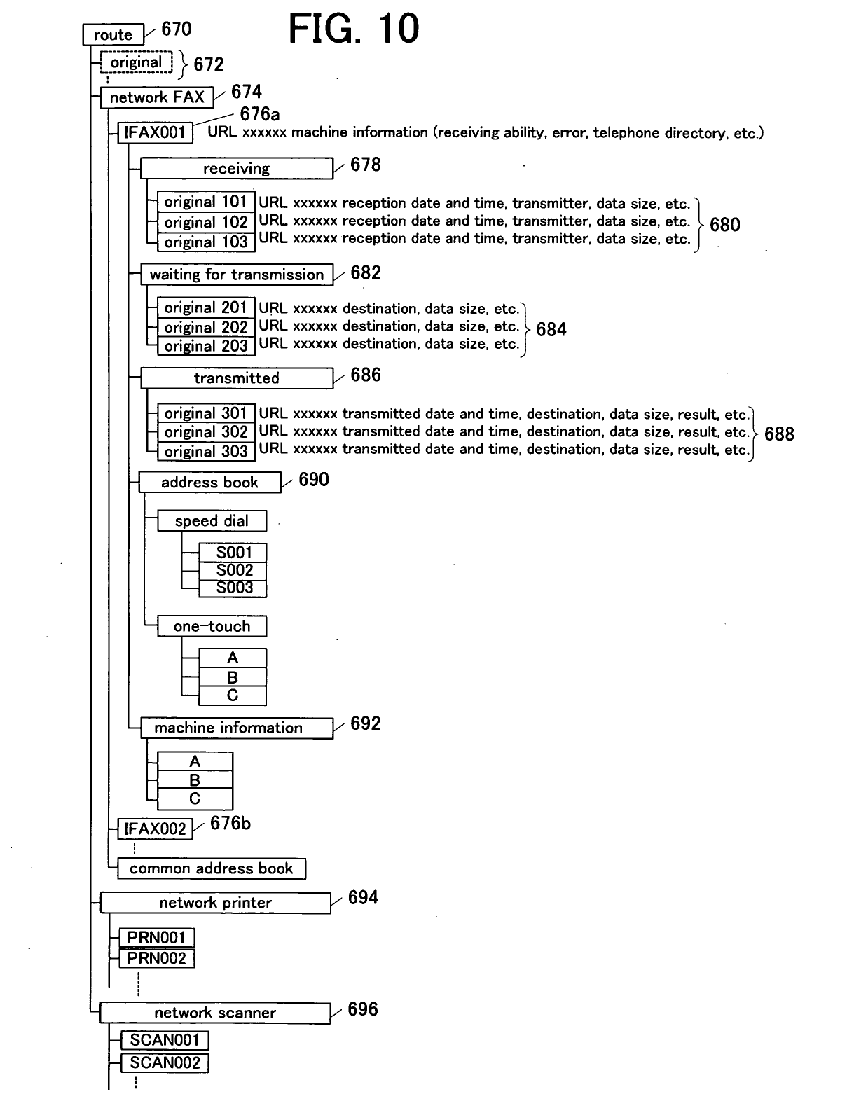

FIG. 10 shows another example of the GUI presented by the first communication device 600 of FIG. 6.

The GUI is displayed with each of the second communication devices 500 in a hierarchy structure like the interface for the file operation. As a route 670 of the hierarchy structure, there is a domain name of the network. Below the domain name, there is a local file display field 672 that shows a structure of data, a file or a folder included in a local disk. At the same hierarchy as the local field, a network facsimile collection 674, a network printer collection 694 and a network scanner collection 696 are displayed. In a hierarchy below the network facsimile collection 674, facsimile machines such as a first facsimile machine 676a and a second facsimile machine 676b are displayed.

In a hierarchy below the first facsimile machine 676a, a reception collection 678, a transmission waiting collection 682, a transmitted collection 686, an address book collection 690 and a machine information collection 692 are displayed.

In a hierarchy below the reception collection 678, a reception resource 680 and a value of the property are displayed. In the same manner, in a hierarchy below the transmission waiting collection 682 and the transmitted collection 686, a transmission waiting resource 684 and a transmitted resource 688 are displayed respectively with the property.

By dragging an icon representing a resource to the reception collection 678 or the like as described in FIG. 7, the GUI having such a hierarchy structure issues a MOVE command without the user being conscious. In the reception resource 680, URLs for identifying three resources, an “original 101”, an “original 102” and an “original 103”, are secured.

When there is a vacancy in the reception resource 680, the first facsimile machine 676a can receive a new resource. A device, which is a destination party of the communication of the first facsimile machine 676a, searches a URL in the reception collection 678 that is not used, and writes a new resource to a position specified by the unused URL. These collections are associated with various processes of the second communication devices 500. When a new resource is written into the collection, an associated process is executed automatically. For example, when a new resource is written into the reception collection 678, a facsimile image can be printed automatically in accordance with the resource.

The second embodiment of the present invention has been described. The above-described embodiment is an example and it is to be understood by those skilled in the art that there are variations to combinations of each of the constituent elements and each of the processes and those variations also fall within the scope of the present invention. For example, the operation accepting unit 610 of FIG. 8 can determine whether or not the resource can be processed by the second communication devices 500. When the resource can be processed, the resource can be moved to a folder. For the determination, the machine information can further include a table that associates the content of the process of the second communication devices 500 with an extension of the resource. When the extension of the resource is included in the table, the operation accepting unit 610 can accept a moving of the resource. Accordingly, a resource that cannot be processed is prevented from being supplied to the second communication devices 500.

For example, in case one of the second communication devices 500 is a video recorder, a program can be recorded by providing program information as the resource. In case one of the second communication devices 500 is an air conditioner, by providing information of room temperature or humidity as a resource, the temperature can be adjusted automatically.

What is claimed is:

1. A communication device comprising:
a storage unit that is specified by identification information in a network and defines a prescribed process for a stored file;
a writing unit that accepts from another communication device connected to the network, an instruction to write a file for executing the prescribed process into the storage unit specified by the identification information, and writes the file into the storage unit; and
means for executing the prescribed process defined in the storage unit by using the file when the file is written into the storage unit.

2. The communication device according to claim 1, further comprising:
means for writing an execution result of the prescribed process based on the file into a prescribed field of the another communication device.

3. The communication device according to claim 1, further comprising:
an authentication unit that authenticates the another communication device which requested the writing of the file;
wherein when the authentication is successful, the writing unit writes the file into the storage unit.

4. The communication device according to claim 3, further comprising:
means for writing an execution result of the prescribed process based on the file into a prescribed field of the another communication device.

5. A communication device comprising:
an acquiring unit that acquires from another communication device connected to a network, machine information of the another communication device;
a determination unit that determines whether a prescribed process can be carried out in the another communication device in accordance with the machine information; and
a writing unit that writes into a storage field of the another communication device, a file for executing the prescribed process by the another communication device, when the prescribed process can be carried out.

6. The communication device according to claim 5, wherein the another communication device includes a plurality of storage fields that can be specified by different identification information respectively;
the machine information includes the identification information and a content of a process carried out when a file is written into a storage field that can be specified by the identification information;
and the writing unit reads from the machine information, identification information that specifies a storage field for executing a desired process, and writes the file into the storage field that can be specified by the identification information.

7. A communication device comprising:
an output unit that assumes information relating to the communication device as a folder or a file and outputs information for controlling the communication device by using an interface for a file operation to another communication device connected to a network;
an accepting unit that accepts from the another communication device, an operation for executing a prescribed process as a file operation; and
a processing unit that executes the prescribed process in accordance with the accepted file operation.

8. The communication device according to claim 7, wherein the folder or the file includes a content of the prescribed process in the communication device, and the accepting unit interprets the accepted file operation as an instruction to the content of the process included in an operated folder or an operated file.

9. The communication device according to claim 7, wherein the file is at least one of data used for executing the prescribed process and internal information of the communication device.

10. The communication device according to claim 7, wherein the folder indicates at least one of the prescribed process of the communication device and the communication device.

11. The communication device according to claim 7, further comprising:
an authentication unit that authenticates the another communication device when accepting a file operation;
wherein the processing unit executes a process according to authentication information to the accepted file operation.

12. The communication device according to claim 11, wherein the output unit outputs information for controlling a process based on the authentication information via an interface for the file operation in accordance with the authentication information.

13. The communication device according to claim 7, wherein the output unit assumes as a folder or a file, information relating to a second another communication device which can be controlled by the communication device, and further outputs information for controlling the second another communication device by using an interface for the file operation and information indicating a hierarchy relation so that the folder or the file relating to the second another communication device is located below a hierarchy of the folder indicating the communication device.

14. A communication device comprising:
a receiving unit that receives from another communication device connected to a network, information relating to the another communication device;
a display unit that assumes information relating to the another communication device as a folder or a file in accordance with the received information and displays as an interface for a file operation; and
an operation unit that carries out an operation instruction to the another communication device in a manner of carrying out a file operation.

15. The communication device according to claim 14, wherein the display unit changes a format of the interface for the file operation according to a process which can be executed by the another communication device.

16. A communication system comprising:
a first communication device that carries out an operation instruction; and
a second communication device that executes a prescribed process according to the operation instruction from the first communication device;
wherein the second communication device comprises:
an output unit that assumes information relating to the second communication device as a folder or a file and outputs information for controlling the second communication device by using an interface for a file operation to the first communication device;
an accepting unit that accepts from the first communication device, a file operation for executing the prescribed process; and
a processing unit that executes the prescribed process in accordance with the accepted file operation;
wherein the first communication device comprises:
a receiving unit that receives information relating to the second communication device;
a display unit that assumes the information relating to the second communication device as a folder or a file in accordance with the received information and displays as an interface for a file operation; and
an instruction unit that carries out an operation instruction to the second communication device in a manner of carrying out a file operation.

17. The communication system according to claim 16, wherein the communication system includes a plurality of second communication devices, and the display unit divides the second communication devices into groups and displays each of the second communication devices in a hierarchy structure for each of the groups.
